(19) United States
(12) Patent Application Publication
(10) Pub. No.: US 2015/0066710 A1
(43) Pub. Date: Mar. 5, 2015

(54) METHOD AND SYSTEM FOR ASSOCIATING DISPLAY MODULES WITH NODES

(71) Applicant: Opticon, Inc., Renton, WA (US)

(72) Inventors: Michael J. Waters, Tukwila, WA (US); Scott McGhee, Seattle, WA (US); Kenneth Y. Ogami, Kirkland, WA (US); Chris Parker, Kent, WA (US)

(73) Assignee: Opticon, Inc., Renton, WA (US)

(21) Appl. No.: 14/137,545

(22) Filed: Dec. 20, 2013

Related U.S. Application Data
(60) Provisional application No. 61/870,648, filed on Aug. 27, 2013.

(51) Int. Cl. G06Q 10/08; H04W 72/08

(52) U.S. Cl. CPC G06Q 10/087; H04W 72/085
USPC 705/28; 370/329

(57) ABSTRACT

A method and system for disassociating an electronic shelf label (ESL) from one node in a network and re-associating the ESL with another node in the network so as to establish a more reliable wireless link for the ESL to receive commands for updating goods-related information display by the ESL.

### FIELD OF THE INVENTION

The present invention relates to a system for wirelessly distributing goods-related visual information to a plurality of electronic shelf labels (ESLs) and, in particular, to a system for distributing goods-related visual information to ESLs with improved wireless reliability.

### BACKGROUND OF THE INVENTION

There have been a number of proposals in the prior art to automate the display of goods-related information in retail establishments, warehouses, supply chains, etc., by using electronic shelf labels (ESLs). To the extent that such systems replace printed tags that have been conventionally used by such establishments these systems are appealing in that they reduce or eliminate the need to reprint and manually replace the printed tags each time the goods-related information of an item is changed. This is beneficial in the sense that it reduces or eliminates the labor required to manually replace the printed tags and the difficulty in manually replacing a large number of printed tags at once.

Although automating the display of goods-related information through the use of wireless ESLs has solved many problems associated with printed tags, the implementation of these systems have brought about new problems for retail establishments.

Wireless ESLs in the prior art rely on infrared, acoustic, or radio-frequency wireless signals to receive information from one or more nodes to update one or more visual displays. The ESLs are pre-assigned to a particular node in a network by, for example, a store manager of the retail establishment. The assignment of the ESL to a particular node is typically based on criteria that are unrelated to signal quality and network traffic. An ESL assigned to a node in this way suffers from deficiencies such as, for example, the inability to dynamically reconfigure itself in situations where the wireless link between the ESL and the node is too weak. Because of this deficiency, there is a lag in receiving signals from the node, which consequently delays the updating of information displayed by the ESL. In extreme cases, deterioration of signal propagation might cause an ESL to become unreachable by the node to which it is assigned. This causes price-related discrepancies at check-out and retail establishments may potentially face great financial losses due to such discrepancies. Therefore, there exists a need to improve the reliability of wireless links between ESLs and nodes in the prior art.

### SUMMARY OF THE INVENTION

Hereinafter, the term “display module” will be used, instead of the more colloquial term “electronic shelf label,” to reflect the fact that such a device might not be necessarily affixed to an edge of a shelf.

In many applications, electronic display modules might be affixed to or placed near a variety of objects, other than shelves, where a programmable display of information might be desired. Although the description of embodiments of the present invention will make reference to retail establishments, it will be clear to those skilled in the art, after reading this disclosure, how to make and use electronic display systems in accordance with the present invention for use in establishments other than retail establishments. For example, and without limitation, such systems might be used in warehouses to assist with inventory maintenance, or in other situations where display of information associated with goods or other items might be desired.

Electronic display systems in accordance with some embodiments of the present invention comprise a plurality of wireless nodes and a plurality of wireless display modules. These nodes are pre-programmed with a “white-list” that identifies one or more display modules that the nodes are to associate with. However, because the quality of the wireless link between a node and a display module may degrade over time, embodiments of the present invention provides a mechanism to dynamically and automatically update the “white-list” so as to associate the display module with a node that will provide a stronger and more reliable wireless link. The present invention and its advantages will be described in more detail below.

Some embodiments of the present invention comprise: receiving, by a display module, a first beacon on a first wireless channel, wherein the first beacon is autonomously and continually broadcasted by a first node in a network without receiving any beacon requests from the display module; receiving, by the display module, a second beacon on a second wireless channel, wherein the second beacon is autonomously and continually broadcasted by a second node in the network without receiving any beacon requests from the display module; and transmitting, by the display module, a first request for association, wherein the first request is transmitted to either the first node or the second node based on an ordering between a first signal strength of the first beacon and a second signal strength of the second beacon.

### BRIEF DESCRIPTION OF THE DRAWINGS

FIG. 1 depicts a schematic diagram of the salient components of a system in accordance with an illustrative embodiment of the present invention.

FIG. 2a through FIG. 2f depicts a flowchart of the salient tasks associated with the operation of the illustrative embodiment of the present invention.

FIG. 3 depicts a flowchart of the salient tasks associated with the operation of task 202 and task 208 in accordance with the illustrative embodiment of the present invention.

FIG. 4 depicts a flowchart of the salient tasks associated with the operation of task 210.

### DETAILED DESCRIPTION

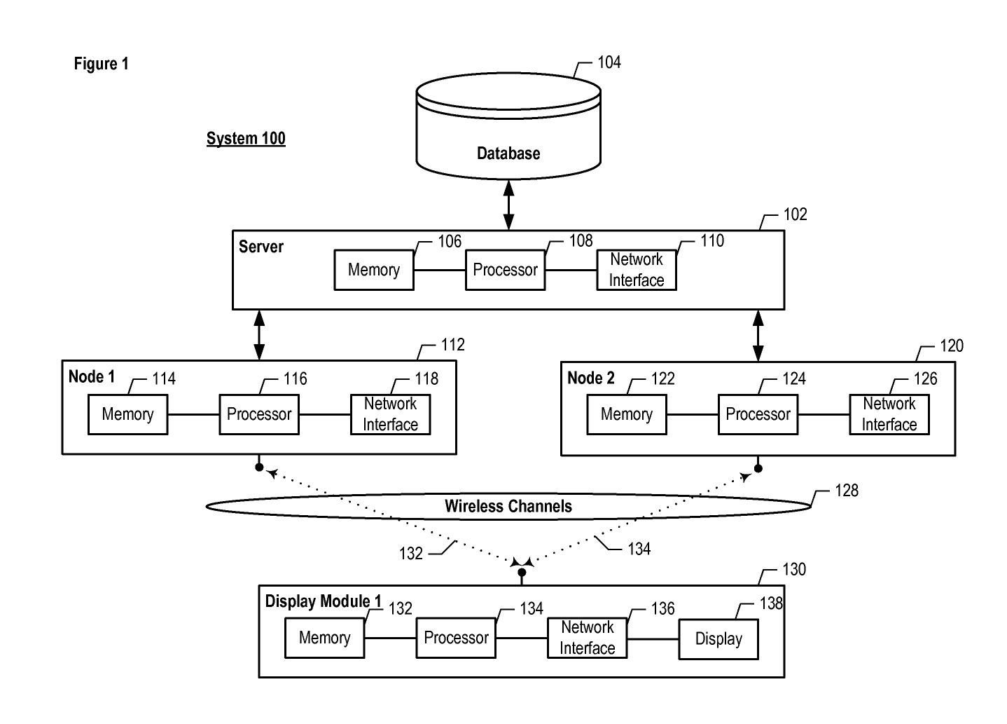

FIG. 1 depicts a schematic diagram of the salient components of system 100 in accordance with an illustrative embodiment of the present invention. System 100 comprises: server 102; database 104; nodes 112 and 120; wireless channels 132 and 134; and display module 130.

Server 102 comprises memory 106, processor 108, and network interface 110. Processor 108 can be a general or special purpose processor, while memory 106 can be random access memory (RAM), read-only memory (ROM), dynamic random-access memory (DRAM), or any combination thereof.

Memory 106 is configured to store one or more computer-readable instructions which, when executed by processor 108, enable server 102 to transmit queries to and receive responses from database 104. In accordance with the illustrative embodiment, the signaling between server 102 and database 104 pertain to, for example, and without limitation, goods-related information and data about the mapping of display modules to nodes.

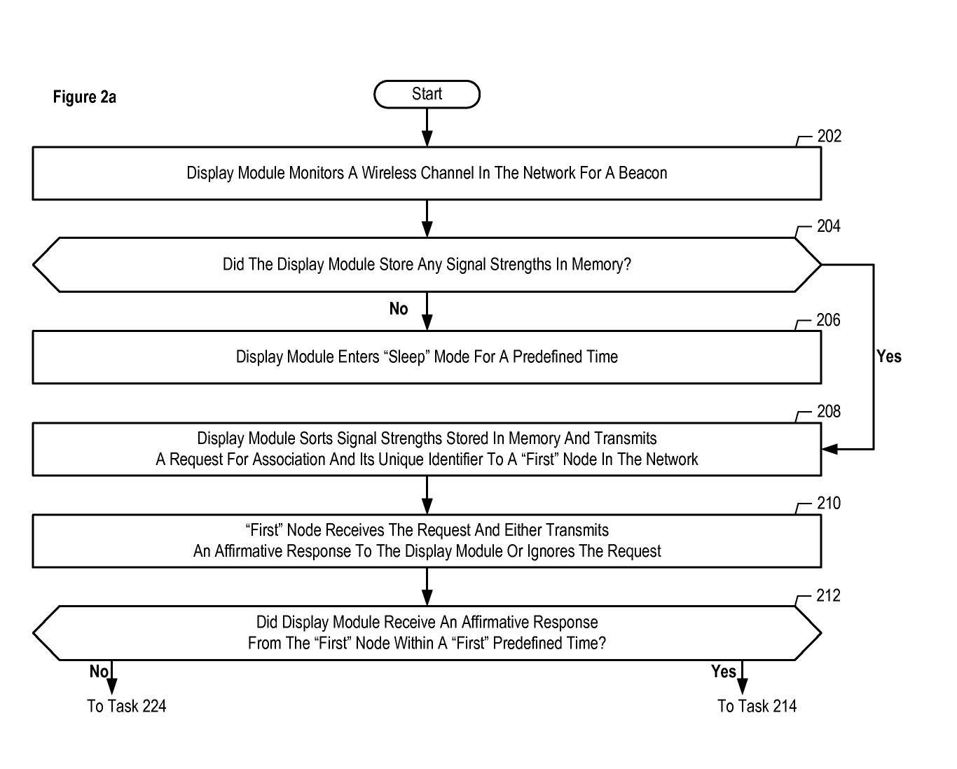

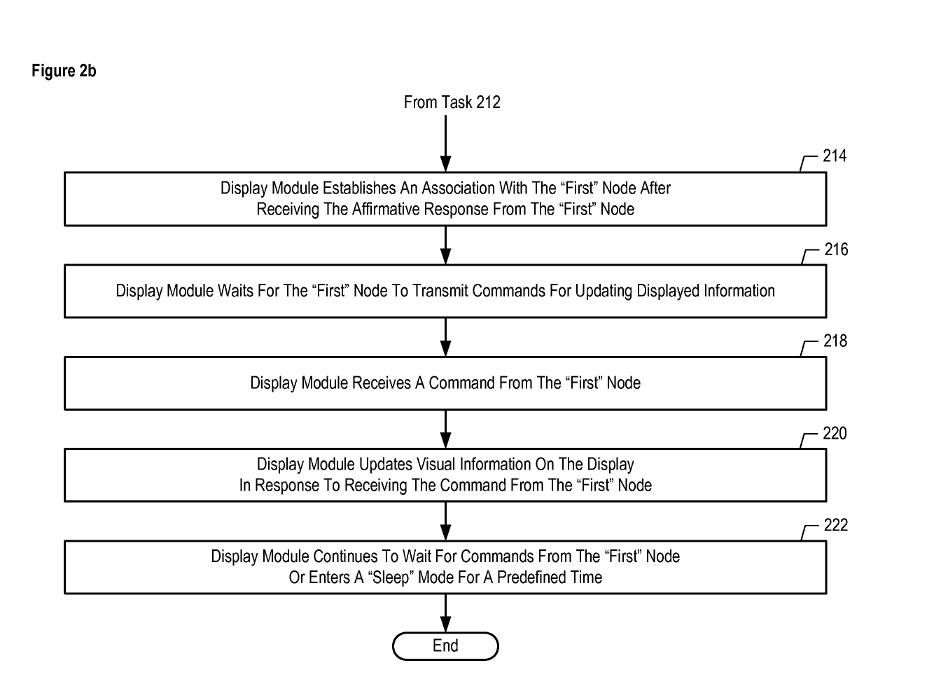

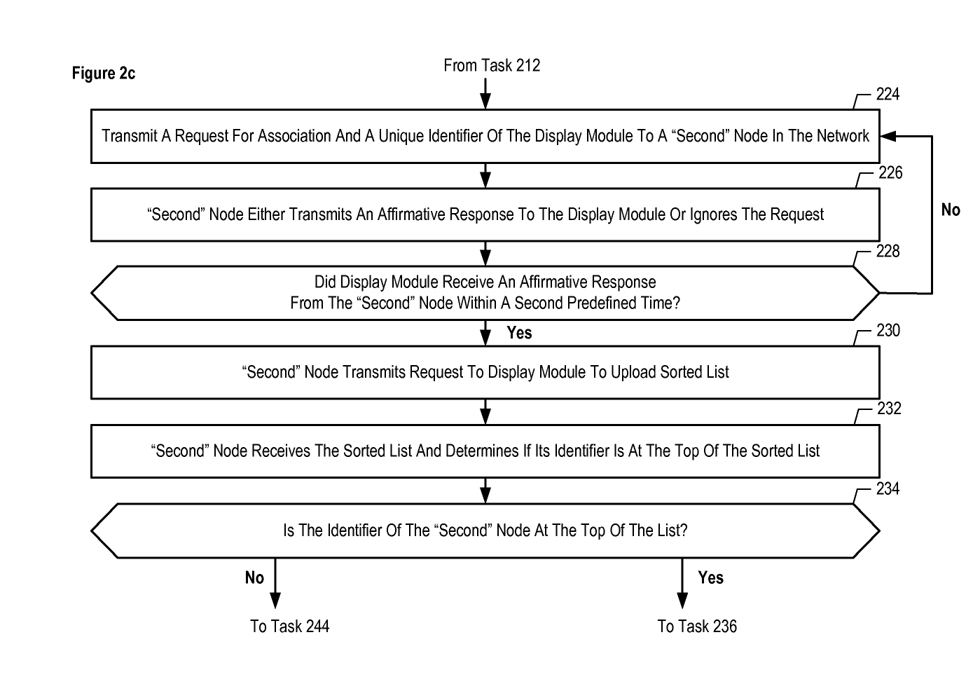

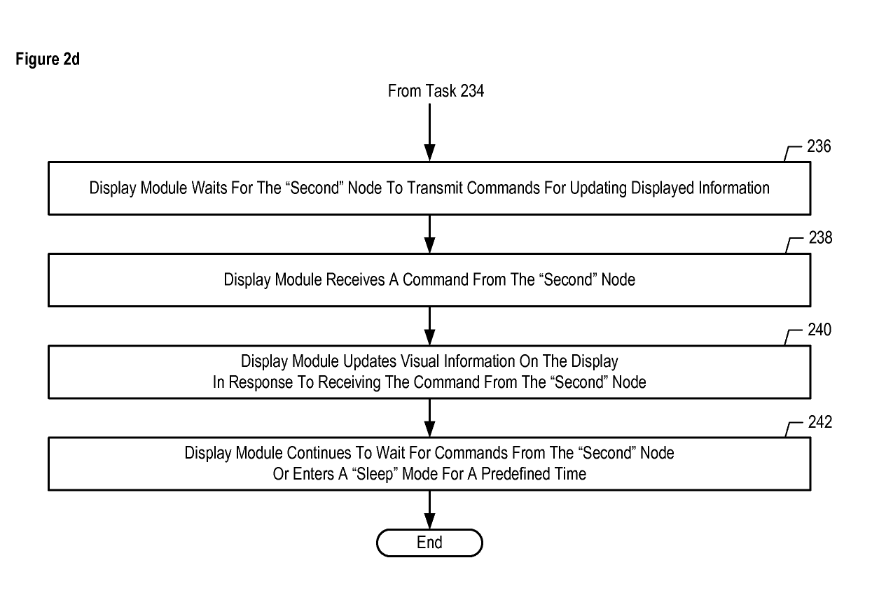

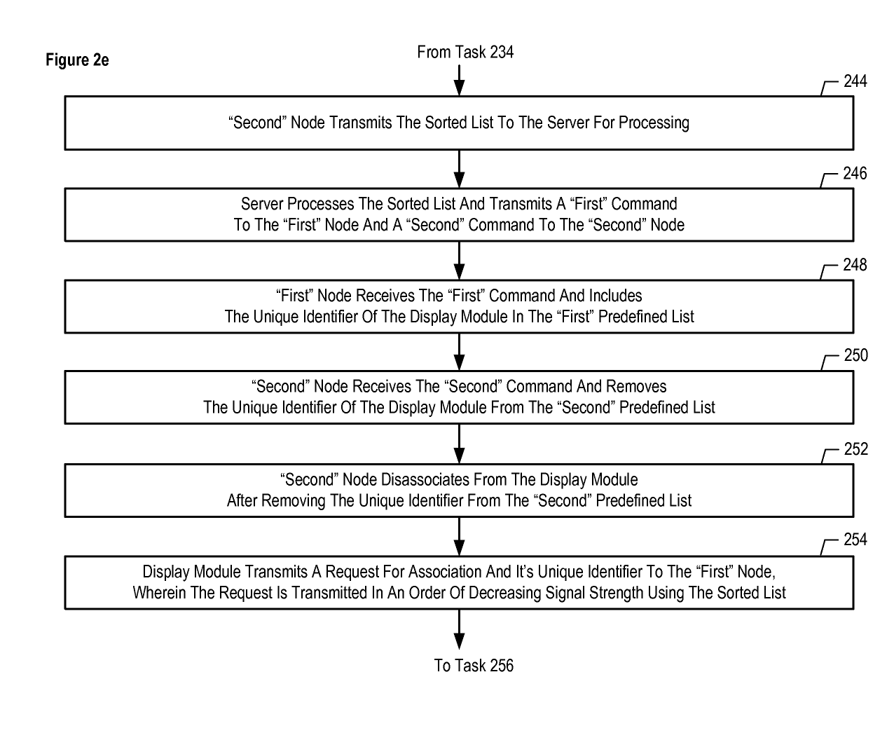

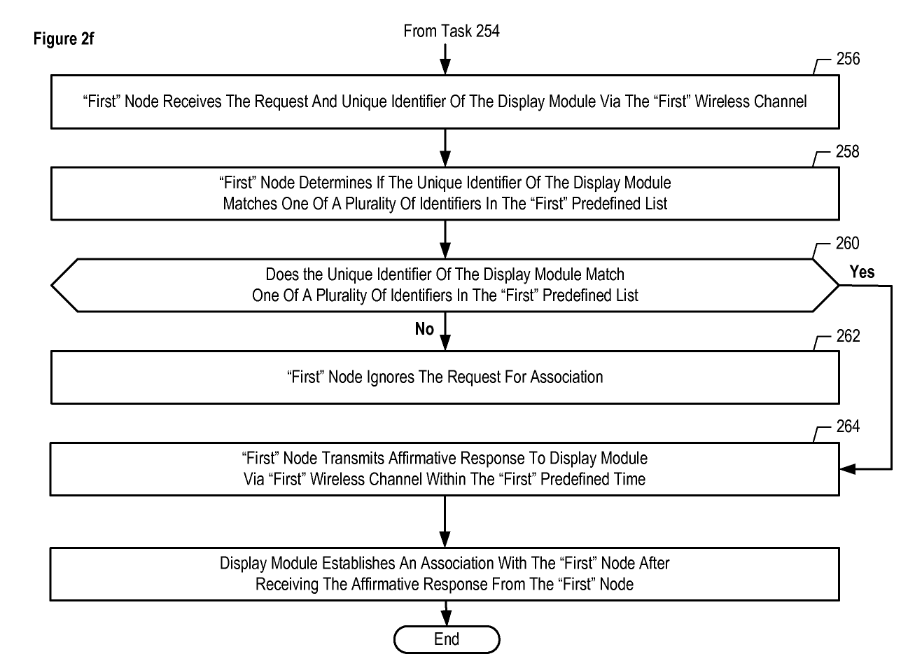

Furthermore, executing the computer-readable instructions stored in memory 106 by processor 108 enables server 102 to communicate one or more commands to nodes 112 and 120. In accordance with the illustrative embodiment, the commands instruct the nodes to, for example, and without limitation, associate with or disassociate from a particular node in the network. The tasks performed by server 102 will be discussed in more detail below, with respect to FIG. 2a through FIG. 2f.

Although the illustrative embodiments comprises one server, it will be clear to those skilled in the art, after reading this disclosure, how to make and use alternative embodiments of the present invention in which system 100 comprises any number of servers (e.g., two servers, three servers, and so on). Further, each of these servers may comprise, for example, substantially the same or different hardware and software elements than server 102.

Database 104 comprises hardware and software that enables it to store, for example, and without limitation, goods-related information and data about the mapping of display modules to nodes. The hardware and software of database 104 also enables it to receive queries from and transmit responses to server 102. Although the illustrative embodiments comprises one database, it will be clear to those skilled in the art, after reading this disclosure, how to make and use alternative embodiments of the present invention in which system 100 comprises any number of databases (e.g., two databases, three databases, and so on). Further, each of these databases may comprise, for example, substantially the same or different hardware and software elements than database 104.

Nodes 112 and 120 respectively comprise memories 114 and 122, processors 116 and 124, and network interfaces 118 and 126. Each of the processors can be a general or special purpose processor, while each of the memories can be random access memory (RAM), read-only memory (ROM), dynamic random-access memory (DRAM), or any combination thereof.

The memories of nodes 112 and 120 are configured to store one or more computer-readable instructions which, when executed by their respective processors, enable them to carry-out the tasks of the illustrative embodiment, as well as alternative embodiments of the present invention. The tasks performed by nodes 112 and 120 will be described in more detail below, with reference to FIG. 2a through FIG. 2f.

Network interfaces 118 and 126 comprise the necessary circuitry for enabling nodes 112 and 120 to transmit and receive signals to and from server 102, either wirelessly or through a dedicated wireline connection. In accordance with the illustrative embodiment, network interfaces 118 and 126 also comprise a transmitter and a receiver for enabling nodes 112 and 120 to wirelessly transmit and receive signals to and from one or more display modules in the network.

Although the illustrative embodiments comprises two nodes, it will be clear to those skilled in the art, after reading this disclosure, how to make and use alternative embodiments of the present invention in which system 100 comprises any number of nodes (e.g., ten nodes, a hundred nodes, a thousand nodes, and so on).

Further, it will also be clear to those skilled in the art, after reading this disclosure, how to make and use alternative embodiments of the present invention in which each node in the network comprises more or less the same hardware elements and computer-readable instructions as nodes 112 and 120 for carrying-out the tasks of FIG. 2a through FIG. 2f.

Display module 130 comprise memory 132, processor 134, network interface 136, and display 138. Processor 134 can be a general or special purpose processor, while memory 132 can be random access memory (RAM), read-only memory (ROM), dynamic random-access memory (DRAM), or any combination thereof.

Memory 132 of display module 130 is configured to store one or more computer-readable instructions which, when executed by processor 134, enables display module 130 to carry-out the tasks of the illustrative embodiment, as well as alternative embodiments of the present invention. The tasks performed by display module 130 will be described in more detail below, with reference to FIG. 2a through FIG. 2f.

Network interface 136 of display module 130 comprises the necessary circuitry for enabling the display module to transmit and receive signals to and from nodes 112 and 120. In accordance with the illustrative embodiment, network interface 136 comprises a transmitter and a receiver for enabling display module 130 to wirelessly transmit and receive signals to and from one or more nodes in the network.

Display 138 employed by module 130 can be, for example, and without limitation, a liquid-crystal display (LCD), a light-emitting diode (LED), a bistable cholesteric display (BCD), an electronic ink display, etc. However, it will be clear to those skilled in the art, after reading this disclosure, how to make and use alternative embodiments of the present invention in which display 138 can be any type or combination of displays.

Although the illustrative embodiments comprises one display module, it will be clear to those skilled in the art, after reading this disclosure, how to make and use alternative embodiments of the present invention in which system 100 comprises any number of display modules (e.g., ten display modules, a hundred display modules, a thousand display modules, and so on).

Further, it will be clear to those skilled in the art, after reading this disclosure, how to make and use alternative embodiments of the present invention in which each display module in the network comprises more or less the same hardware elements and computer-readable instructions as display module 130 for carrying-out the tasks of FIG. 2a through FIG. 2f.

FIG. 2a depicts some of the salient tasks associated with the illustrative embodiment of the present invention. In accordance with the illustrative embodiment, the flowchart begins with display module 130 being powered-on or exiting a “sleep” mode. Once display module 130 enters an active state, the illustrative embodiment moves to task 202.

At task 202, display module 130 monitors each wireless channel in the network for beacons. The beacons are autonomously and continually broadcasted by nodes in the network on their respective wireless channels without receiving any beacon requests from display module 130; or any other display modules in system 100 for that matter.

As an example, node 112 (i.e., a “first” node) autonomously and continually broadcasts a beacon (i.e., a “first” beacon) onto wireless channel 132 (i.e., a “first” wireless channel) without receiving any beacon requests from display module 130. Likewise, node 120 (i.e., a “second” node) autonomously and continually broadcasts a beacon (i.e., a “second” beacon) onto wireless channel 134 (i.e., a “second” wireless channel) without receiving any beacon requests from display module 130.

Although the illustrative embodiment only depicts two wireless channels, it will be clear to those skilled in the art, after reading this disclosure, how to make and use alternative embodiments in which system 100 comprises a number of wireless channels (e.g., three wireless channels, ten wireless channels, and so on) and a number of nodes that autonomously and continually broadcast beacons on their respective wireless channels.

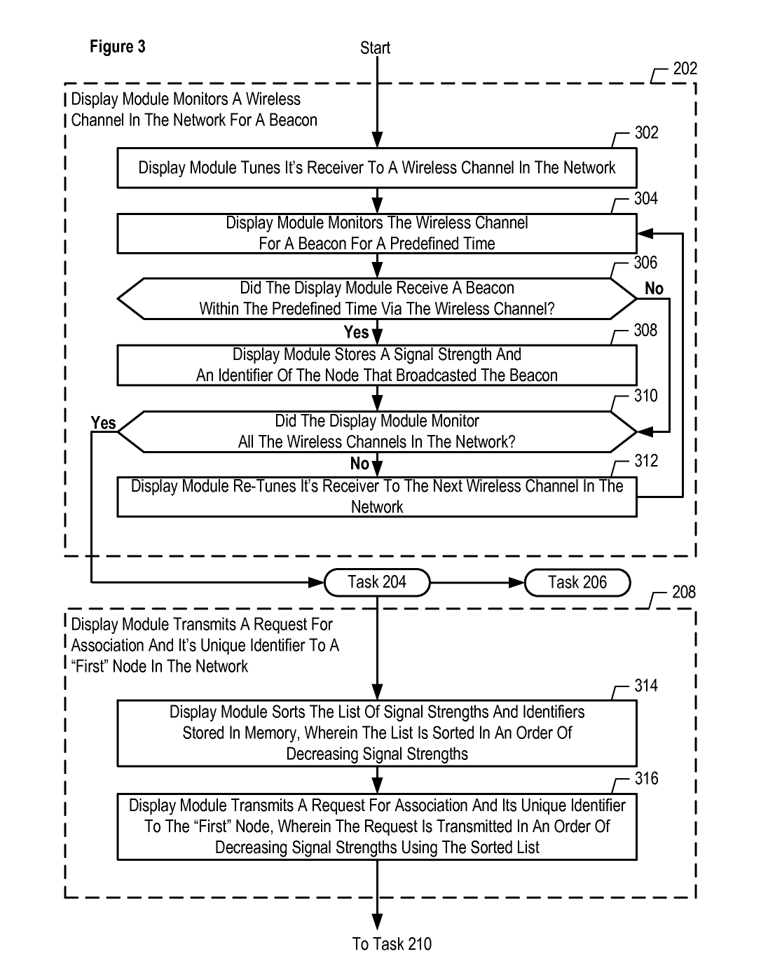

In accordance with the illustrative embodiment, display module 130 may or may not receive any beacons while monitoring the wireless channels at task 202. In situations where display module 130 receive a beacon while monitoring a particular wireless channel, display module 130 is configured to determine the signal strength of the received beacon. Once determined, display module 130 stores the signal strength of the received beacon in memory 132, along with an identifier of the node that broadcasted the beacon. Task 202 will be described in more detail below, with reference to FIG. 3.

At task 204, display module 130 determines if there are any signal strengths of beacons stored in memory 132 as a result of monitoring the wireless channels in the network. If display module 130 determines that there are no signal strengths of beacons stored in memory 132, the illustrative embodiment moves to task 206. On the other hand, if display module 130 determines that there are one or more signal strengths of beacons stored in memory 132, the illustrative embodiment moves to task 208.

At task 206, display module 130 enters a sleep mode for a predefined time in response to determining that there are no signal strengths of beacons stored in memory 132. The predefined time can be, for example, and without limitation, thirty-minutes, one-hour, five-hours, and so on. In accordance with the illustrative embodiment, display module 130 is pre-configured by a system administrator with the predefined time for entering and exiting sleep mode. Further, display module 130 in accordance with the illustrative embodiment is configured to automatically and dynamically update the predefined time for entering and exiting sleep mode based on certain characteristics of the network or changes that are made to system 100. In any event, display module 130 will eventually exit sleep mode after a predefined time so as to repeat task 202 of monitoring each wireless channel in the network for beacons.

At task 208, display module 130 sorts the signal strengths and identifiers stored in memory 132 in response to determining that there are indeed signal strengths of beacons stored in memory 132. In accordance with the illustrative embodiment, memory 132 comprises the following signal strengths and identifiers after performing task 202:
a “first” signal strength of a beacon that is broadcasted by node 112 on wireless channel 132, wherein the first signal strength is stored in memory 132 along with an identifier of node 112; and
a “second” signal strength of a beacon that is broadcasted by node 120 on wireless channel 134, wherein the second signal strength is stored in memory 132 along with an identifier of node 120. These signal strengths and identifiers stored in memory 132 are sorted by display module 130 in an order of decreasing signal strengths, but it will be clear to those skilled in the art, after reading this disclosure, how to make and use alternative embodiments of the present invention in which the signal strengths and identifiers are sorted in any order.

For example, and without limitation, the identifier of node 112 would precede the identifier of node 120 in the sorted list if display module 130 determines that the first signal strength is stronger than the second signal strength. In this example, the first signal strength of the beacon broadcasted by node 112 would likewise precede the second signal strength of the beacon broadcasted by node 120 in the sorted list.

Although the example above describes memory 132 as storing only two signal strengths, it will be clear to those skilled in the art, after reading this disclosure, how to make and us alternative embodiments of the present invention in which memory 132 stores a number of signal strengths (e.g., five signal strengths, ten signal strengths, and so on) and a number of identifiers of nodes (e.g., five identifiers, ten identifiers, and so on) as a result of performing task 202.

For the purpose of enabling the reader of this disclosure to more easily understand the present invention, the sorting performed by the illustrative embodiment causes the identifier of node 112 to precede the identifier of node 120 in the sorted list. Likewise, the sorting display module 130 causes the first signal strength to precede the second signal strength in the sorted list. Having sorted the identifiers and signal strengths in this way, display module 130 transmit a request for association to a node in the network based on an order of decreasing signal strength using the sorted list.

Since the first signal strength and the identifier of node 112 appear at the top of the sorted list, and because display module 130 is configured to transmit requests for association based on an order of decreasing signal strengths using the sorted list, display module 130 will initially transmit the request (i.e., a “first” request) to node 112 (i.e., a “first” node) via wireless channel 132 (i.e., a “first” wireless channel).

In addition to transmitting the request to node 112, display module 130 also transmits its unique identifier to node 112 via wireless channel 132. The unique identifier in accordance with the illustrative embodiment is the Media Access Control (MAC) address of display module 130. However, it will be clear to those skilled in the art, after reading this disclosure, how to make and use alternative embodiments of the present invention in which other types of unique identifiers can be used, so long as the identifier can uniquely distinguish one display module from other display modules in the network. Task 208 will be described in more detail below, with reference to FIG. 3.

At task 210, node 112 receives the request and the MAC address from display module 130 via wireless channel 132. Once received, node 112 determines if the MAC address of display module 130 matches one of a plurality of identifiers in a predefined list (i.e., a “first” predefined list) stored in memory 114. The predefined list is, for example, a “white-list” that comprises one or more identifiers of display modules in which node 112 is configured to associate with. Furthermore, the predefined list is assigned to node 112 by server 102, wherein a copy of the predefined list is either stored in memory 106 of server 102 or database 104.

Having described the illustrative embodiment of the present invention thus far, it should be noted at this point of the disclosure that two scenarios can occur after node 112 receives the request and the MAC address from display module 130.

In the first scenario, node 112 transmits an affirmative response to display module 130 via wireless channel 132 if it determines that the MAC address matches one of the identifiers in the predefined list. This scenario corresponds to tasks 214, 216, 218, 220, and 222 of FIG. 2b, which will be described in more detail below.

In the second scenario, node 112 ignores the request for association transmitted by display module 130 if it determines that the MAC address does not match one of the identifiers in the predefined list. This scenario corresponds to the tasks of FIG. 2c through FIG. 2f, which will be described in more detail below.

First Scenario—Node Determines that there is a Match

FIG. 2b. At task 212, display module 130 monitors wireless channel 132 and determines whether an affirmative response (i.e., a “first” affirmative response) to the request has been received from node 112 within a predefined time (i.e., a “first” predefined time).

At task 214, display module 130 receives the affirmative response from node 112 via wireless channel 132 within the predefined time as a result of the determination performed at task 210—i.e., node 112 determines that the MAC address matches one of the identifiers in the predefined list. By receiving the affirmative response, this enables display module 130 to establish an association with node 112. From this point on, display module 130 and node 112 will perform the necessary signaling to establish an association with each other and, thereafter, communicate via wireless channel 132.

At task 216, display module 130 monitors wireless channel 132 for one or more commands transmitted by node 112. In accordance with the illustrative embodiment, the one or more commands can be, for example, and without limitation, commands to update goods-related visual information on display 138, wherein the goods-related visual information can be the price, quantity, image, text, etc. of an item. In accordance with alternative embodiments, the commands are to update goods-related visual information on display 138 so as to reflect changes that might have occurred in database 104.

At task 218, display module 130 receives the one or more commands from node 112 via wireless channel 132.

At task 220, display module 130 updates the goods-related visual information on display 138 in response to receiving the one or more commands. That is, processor 134 of display module 130 executes the computer-readable instructions of the commands and updates the goods-related visual information on display 138.

At task 222, display module 130 either continues to wait for commands from node 112 or enters a “sleep” mode for a predefined time until repeating task 202.

In general, the scenario described above may occur when a system administrator has correctly determined from the onset that the most reliable wireless link for display module 130 to receive commands is to associate it with node 112.

Stated differently, the system administrator has correctly included the MAC address of display module 130 in the predefined list (which is assigned to node 112 by server 102) with the expectation that such pairing would result in the most reliable wireless link for display module 130 to receive commands. The system administrator's expectation might have been a result of intuitively determining that a more reliable wireless link can be achieved if the display module is paired with a node that is geographically located in the same department of a retail establishment.

In sum, the scenario described above pertains to the situation in which the predefined list of node 112 has been correctly configured by a system administrator to include the MAC address of display module 130.

Second Scenario—Node Determines that there is No Match

In this scenario, the predefined list of node 120 is configured by a system administrator from the onset to include the MAC address of display module 130 (for the reasons discussed above). Since the pairing of display module 130 to node 120 is believed to produce the most reliable wireless link, the system administrator does not include the MAC address of display module 130 in the predefined list of node 112.

However, because of various changes that might have occurred in system 100 or the network, the wireless link between node 120 and display module 130 has become unreliable. This second scenario provides a mechanism for re-associating display module 130 to node 112 to achieve a more reliable wireless link.

FIG. 2c. At task 212, display module 130 monitors wireless channel 132 and determines whether an affirmative response (i.e., a “first” affirmative response) to the request has been received from node 112 within a predefined time (i.e., a “first” predefined time).

At task 224, display module 130 retrieves the sorted list of signal strengths from memory 132 in response to determining that it has not received the affirmative response from node 112 via wireless channel 132 within the predefined time. The reason why display module 130 did not receive the affirmative response is because node 112 ignored the request for association as a result of determining that the MAC address of display module 130 is not in the predefined list, per task 210 above.

Using the sorted list, display module 130 determines the next strongest signal strength (relative to the first signal strength) in the sorted list. According to the illustrative embodiment, the second signal strength (which corresponds to the beacon broadcasted by node 120) has the next strongest signal strength in the sorted list. As such, display module 130 transmits a request for association (i.e., a “second” request) along with its MAC address to node 120 (i.e., a “second” node) via wireless channel 134 (i.e., a “second” wireless channel).

At task 226, node 120 receives the request and the MAC address from display module 130 via wireless channel 134. Once received, node 120 determines if the MAC address of display module 130 matches one of a plurality of identifiers in a predefined list (i.e., a “second” predefined list) stored in memory 122. The predefined list is, for example, a “white-list” that comprises one or more identifiers of display modules in which node 120 is configured to associate with.

At task 228, display module 130 monitors wireless channel 134 and determines whether an affirmative response (i.e., a “second” affirmative response) to the request has been received from node 120 within a predefined time (i.e., a “second” predefined time).

If display module 130 determines that an affirmative response from node 120 has not been received within the predefined time, the illustrative embodiment repeats task 224. In other words, display module repeats the step of iteratively transmitting requests for association to other nodes in the network in an order of decreasing signal strengths using the sorted list. When none of these nodes respond to the request with an affirmative response, then display module 130 enters a “sleep” mode for a predefined time before repeating task 202.

On the other hand, if display module 130 determines that the affirmative response from node 120 has been received via wireless channel 134 within the predefined time, the illustrative embodiment moves to task 230. In accordance with the illustrative embodiment, display module 130 receives the affirmative response from node 120 via wireless channel 134 within the predefined time. By receiving the affirmative response, this enables display module 130 to establish an association with node 120. From this point on, display module 130 and node 120 will perform the necessary signaling to establish an association with each other and, thereafter, communicate via wireless channel 134.

At task 230, node 120 transmits a command to display module 130 via wireless channel 134, wherein the command instructs display module 130 to upload the sorted list stored in memory 132 to node 120 via wireless channel 134.

At task 232, display module 130 transmits the sorted list to node 120 via wireless channel 134 after receiving the command.

At task 234, node 120 receives the sorted list and determines if its identifier is at the top of the sorted list. If the identifier of node 120 is at the top of the sorted list, then the illustrative embodiment moves to task 236, which will be described in more detail below, with reference to FIG. 2d. On the other hand, if the identifier of node 120 is not at the top of the sorted list, then the illustrative embodiment moves to task 244, which will be described in more detail below, with reference to FIG. 2e.

### Identifier of Node is Determined to be at the to of the Sorted List

FIG. 2d. At task 234, node 120 receives the sorted list and determines if its identifier is at the top of the sorted list. In this exemplary scenario, node 120 determines that its identifier is indeed at the top of the sorted list and, therefore, continues to associate with display module 130.

At task 236, display module 130 monitors wireless channel 134 for one or more commands transmitted by node 120. In accordance with the illustrative embodiment, the one or more commands can be, for example, and without limitation, commands to update goods-related visual information on display 138, wherein the goods-related visual information can be the price, quantity, image, text, etc. of an item. In accordance with alternative embodiments, the commands are to update the goods-related visual information on display 138 so as to reflect changes that might have occurred in database 104.

At task 238, display module 130 receives the one or more commands from node 120 via wireless channel 134.

At task 240, display module 130 updates the goods-related visual information on display 138 in response to receiving the one or more commands. That is, processor 134 of display module 130 executes the computer-readable instructions of the commands and updates the goods-related visual information on display 138.

At task 242, display module 130 either continues to wait for commands from node 120 or enters a “sleep” mode for a predefined time until repeating task 202.

### Identifier of Node is not at the to of the Sorted List

FIG. 2e. At task 234, node 120 receives the sorted list and determines if its identifier is at the top of the sorted list. In this exemplary scenario, node 120 determines that its identifier is not at the top of the sorted list.

At task 244, node 120 transmits the sorted list to server 102 in response to determining that its identifier is not at the top of the sorted list. The MAC address of display module 130 is likewise transmitted from node 120 to server 102.

At task 246, server 102 processes the sorted list to determine why display module 130 did not initially associate with the node at the top of the list—namely, node 112 according to the illustrative embodiment.

The advantage of this determination is that the association between display module 130 and node 120 can be dynamically reconfigured such that display module 130 associates with node 112. By dynamically reconfiguring system 100 in this way, it enables display module 130 to associate with a node in the network that would presumably provide a more reliable wireless link. Since the signal strength of the beacon broadcasted by node 112 is determined to be the strongest at task 208, associating display module 130 with node 112 would be advantageous as a more reliable wireless link can be established for transmitting commands to, and receiving signals from, display module 130.

In order for server 102 to determine why display module did not initially associate with node 112, server 102 analyzes the service set identifier (SSID) of node 112 to see whether it belongs to the network of system 100. If the SSID of node 112 does not belong to system 100, then server 102 continues allowing display module 130 to associate with node 120. This situation may occur, for example, when node 112 belongs to a network that is in a different building or retail establishment.

On the other hand, when server 102 determines that the SSID of node 112 belongs to system 100, server 102 retrieves a copy of the predefined list assigned to node 112. Since server 102 is the one that pre-configured each node in the network with a predefined list of display modules to associate with, server 102 can simply retrieve the predefined list from its own memory or from database 104.

In any case, once server 102 retrieves the predefined list, it determines if the MAC address of display module 130 is in the predefined list assigned to node 112. When server 102 determines that the MAC address of display module 130 is not in the predefined list, server 102 transmits a command to node 112 and another command to node 120.

At task 248, node 112 receives the command (i.e., a “first” command) from server 102. Responsive to the command, node 112 includes the MAC address of display module 130 in its predefined list that is stored in memory 114.

At task 250, node 120 receives the other command (i.e., a “second” command) from server 102. Responsive to the command, node 120 removes the MAC address of display module 130 from its predefined list that is stored in memory 122.

At task 252, node 120 disassociates from display module 130 as a result of removing the MAC address of display module 130 from its predefined list.

At task 254, display module 130 retrieves the sorted list from its memory after disassociating from node 120 and thereafter transmits a request for association (i.e., a “third” request) based on an order of decreasing signal strengths using the sorted list. Since the signal strength and identifier of node 112 precedes the signal strength and identifier of node 120 in the sorted list as determined at task 208, display module 130 transmits the request and its MAC address to node 112 via wireless channel 132.

At task 256 of FIG. 2f, node 112 receives the request and the MAC address from display module 130 via wireless channel 132.

At tasks 258 and 260, node 112 determines if the MAC address of display module 130 matches one of a plurality of identifiers in the predefined list stored in memory 114.

At task 262, display module 112 ignores the request received from display module 130 if the MAC address of display module 130 does not match one of the plurality of identifiers in the predefined list stored in memory 114. However, this would not be the case since, as described above, the predefined list stored in node 112 has be updated to include the MAC address of display module 130 at task 248.

At task 264, display module 112 transmits an affirmative response (i.e., a “third” affirmative response) to display module 130 via wireless channel 132 in response to determining that the MAC address of display module 130 does indeed match one of the plurality of identifiers in the predefined list stored in memory 114.

At task 266, display module 130 receives the affirmative response from node 112 via wireless channel 132 within the predefined time. By receiving the affirmative response, this enables display module 130 to establish an association with node 112. From this point on, display module 130 and node 112 will perform the necessary signaling to establish an association with each other and, thereafter, communicate via wireless channel 132.

Once the association has been established, display module 130 monitors wireless channel 132 for one or more commands transmitted by node 112. In accordance with the illustrative embodiment, display module 130 receives one or more commands from node 112 via wireless channel 132 and updates the goods-related visual information on display 138. The one or more commands can be, for example, and without limitation, commands to update one or more goods-related visual information on display 138 to reflect changes that might have occurred in database 104. Further, the goods-related visual information can be, for example, and without limitation, the price, quantity, image, text, etc. of an item. After updating display 138, display module either continues to wait for commands from node 112 or enters a “sleep” mode for a predefined time until repeating task 202

FIG. 3 depicts a flowchart of the salient tasks associated with the operation of task 202 and task 208 in accordance with the illustrative embodiment of the present invention.

At task 302, display module 130 turns-on its receiver and tunes it to a particular wireless channel in the network, without ever turning-on its transmitter. More specifically, the transmitter of display module 130 remains in an off state from tasks 202, 204, and 206, up until task 208. In accordance with the illustrative embodiment, display module 130 initially tunes its receiver to wireless channel 132 (i.e., a “first” wireless channel).

At task 304, display module 130 monitors' wireless channel 132 for beacons. As discussed at the beginning of this disclosure, the beacons are autonomously and continually broadcasted by node 112 (i.e., a “first” node) via wireless channel 132.

At task 306, display module 130 determines if it has received a beacon while monitoring wireless channel 132 within a predefined time. If display module 130 received a beacon (i.e., a “first” beacon) via wireless channel 132 within the predefined time, the illustrative embodiment moves to task 308; otherwise, the illustrative embodiment moves to task 310.

At task 308, display module 130 stores a signal strength (i.e., a “first” signal strength) and an identifier of node 112 (i.e., a “first” identifier”) in memory 132.

At task 310, display module 130 determines if it has monitored all the wireless channels in the network. If display module 130 did not monitor all the wireless channels in the network, the illustrative embodiment moves back to task 312; otherwise, the illustrative embodiment moves to task 204 of FIG. 2a.

At task 312, display module re-tunes its receiver to another wireless channel in the network. In accordance with the illustrative embodiment, display module re-tunes its receiver to wireless channel 134 (i.e., a “second” wireless channel) and repeats tasks 304, 306, 308, 310, and 312.

For completeness, at task 304, display module 130 monitors wireless channel 134 for beacons. As discussed at the beginning of this disclosure, the beacons are autonomously and continually broadcasted by node 120 (i.e., a “second” node) via wireless channel 134.

At task 306, display module 130 determines if it has received a beacon while monitoring wireless channel 134 within a predefined time. If display module 130 received a beacon (i.e., a “second” beacon) via wireless channel 134 within the predefined time, the illustrative embodiment moves to task 308; otherwise, the illustrative embodiment moves to task 310.

At task 308, display module 130 stores a signal strength (i.e., a “second” signal strength) and an identifier of node 120 (i.e., a “second” identifier”) in memory 132.

At task 310, display module 130 determines if it has monitored all the wireless channels in the network. If display module 130 did not monitor all the wireless channels in the network, the illustrative embodiment moves back to task 312; otherwise, the illustrative embodiment moves to task 204 of FIG. 2a.

It will be clear to those skilled in the art, after reading this disclosure, how to make and use alternative embodiments of the present invention in which display module 130 will re-tune its receiver according to task 312 and repeat the tasks of 304, 306, 308, 310, and 312 until all wireless channels in the network have been monitored. Once all of the wireless channels in the network have been monitored for beacons, the illustrative embodiment moves to task 204. Depending on the outcome of the determination performed at task 204, display module 130 will either perform the salient operations of task 206 or task 208.

At task 314, display module 130 sorts the signal strengths and identifiers stored in memory 132 in an order of decreasing signal strengths. In accordance with the illustrative embodiment, the first and second signal strengths are sorted by display module 130 such that the identifier of node 112 precedes the identifier of node 120 in the sorted list.

Since the first signal strength and the identifier of node 112 appear at the top of the sorted list, and because display module 130 is configured to transmit requests for association based on an order of decreasing signal strengths using the sorted list, display module 130 initially transmits a request for association (i.e., a “first” request) to node 112 via wireless channel 132. Once the request has been transmitted, the illustrative embodiment moves to task 210 of FIG. 2a.

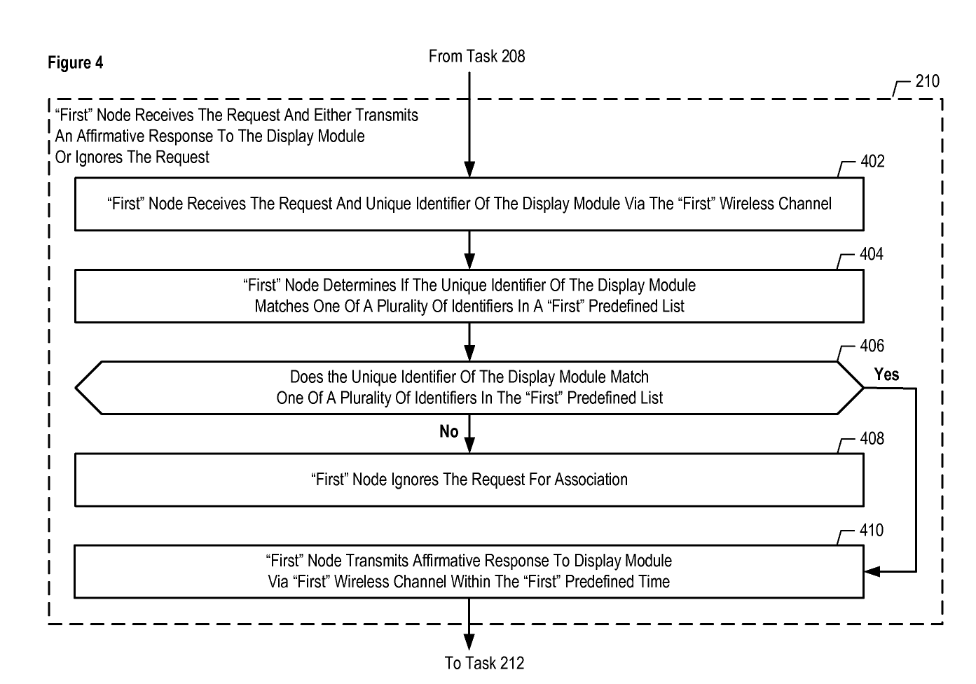

FIG. 4 depicts a flowchart of the salient tasks associated with the operation of task 210.

At task 402, node 112 receives the request and the MAC address from display module 130 via wireless channel 132.

At tasks 404 and 406, node 112 determines if the MAC address of display module 130 matches one of a plurality of identifiers in a predefined list (i.e., a “first” predefined list) stored in memory 114. The predefined list is, for example, a “white-list” that comprises one or more identifiers of display modules in which node 112 is configured to associate with.

At task 408, node 112 ignores the request for association from display module 130 if the determination reveals that the MAC address does not match one of the identifiers in the predefined list.

At task 410, node 112 transmits an affirmative response (i.e., a “first” affirmative response) to display module 130 in response to determining that the MAC address matches one of the identifiers in the predefined list. Once the affirmative response has been transmitted, the illustrative embodiment moves to task 212 of FIG. 2a.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving, by a display module, a first beacon on a first wireless channel, wherein the first beacon is autonomously and continually broadcasted by a first node in a network without receiving any beacon requests from the display module;
receiving, by the display module, a second beacon on a second wireless channel, wherein the second beacon is autonomously and continually broadcasted by a second node in the network without receiving any beacon requests from the display module; and
transmitting, by the display module, a first request for association, wherein the first request is transmitted to either the first node or the second node based on an ordering between a first signal strength of the first beacon and a second signal strength of the second beacon.

2. The method of claim 1 wherein, prior to the step of receiving the first beacon, the display module enables its receiver without enabling its transmitter to search for the first beacon on the first wireless channel and the second beacon on the second wireless channel.

3. The method of claim 1 further comprising:
storing, by the display module, the first signal strength of the first beacon and the second signal strength of the second beacon; and
sorting, by the display module, the first signal strength and the second signal strength, wherein the first signal strength and the second signal strength are sorted in the order of decreasing signal strengths.

4. The method of claim 3, wherein the first signal strength and the second signal strength are sorted in the order of decreasing signal strengths such that a first identifier of the first node precedes a second identifier of the second node in the sorted list.

5. The method of claim 4, wherein the first request is transmitted in the order of decreasing signal strengths using the sorted list, and wherein transmission of the first request commences with the first request being transmitted to the first node as a result of the display module identifying that the first identifier precedes the second identifier in the sorted list.

6. The method of claim 5, wherein transmission of the first request comprises:
tuning a transmitter and a receiver of the display module to the first wireless channel, and
transmitting the first request and a unique identifier of the display module to the first node via the first wireless channel;
wherein the receiver remains tuned to the first wireless channel for a first predefined time during which it monitors if a first affirmative response from the first node is present on the first wireless channel.

7. The method of claim 6, wherein the first node receives the first request and determines if the unique identifier of the display module matches one of a plurality of identifiers in a first predefined list stored at the first node; and
wherein the first node does not respond with the first affirmative response as a result of determining that the unique identifier fails to match one of the plurality of identifiers in the first predefined list.

8. The method of claim 7 further comprising:
re-tuning, by the display module, the transmitter and the receiver to the second wireless channel for a second predefined time as a result of determining that it has failed to receive the first affirmative response from the first node within the first predefined time, wherein the transmitter and receiver are re-tuned to the second wireless channel based on the order of decreasing signal strengths in the sorted list; and
transmitting, by the display module, a second request and the unique identifier of the display module to the second node via the second wireless channel after the transmitter and the receiver are re-tuned.

9. The method of claim 8, wherein the second node receives the second request and determines if the unique identifier of the display module matches one of a plurality of identifiers in a second predefined list stored at the second node; and
wherein the second node transmits a second affirmative response to the display module as a result of determining that the unique identifier matches one of the plurality of identifiers in the second predefined list.

10. The method of claim 9 further comprising:
receiving, by the display module, the second affirmative response from the second node via the second wireless channel within the second predefined time;
establishing, by the display module, an association with the second node after receiving the second response from the second node; and
uploading, by the display module, the sorted list to the second node via the second wireless channel.

11. The method of claim 10, wherein the second node receives the sorted list and determines if the second identifier is at the top of the sorted list; and
wherein the second node transmits the sorted list to a server as a result of determining that the second identifier is not at the top of the sorted list.

12. The method of claim 11, wherein the server receives the sorted list and processes it to determine whether or not the first node satisfies a criterion, and when the server determines that the first node satisfies the criterion, the server:
transmits a first command to the first node to include the unique identifier of the display module in the first predefined list, and
transmits a second command to the second node to remove the unique identifier of the display module from the second predefined list.

13. The method of claim 12, wherein the second node receives the second command from the server and removes the unique identifier of the display module from the second predefined list, thereby causing the second node and the display module to disassociate from one another; and
wherein the first node receives the first command from the server and includes the unique identifier of the display module in the first predefined list.

14. The method of claim 13, further comprising transmitting a third request and the unique identifier to the first node via the first wireless channel by the display module.

15. The method of claim 14 further comprising:
receiving, by the display module, a third affirmative response from the first node via the first wireless channel within the first predefined time;
establishing, by the display module, an association with the first node after receiving the third affirmative response from the first node;
receiving, by the display module, instructions from the first node via the first wireless channel after association; and
updating, by the display module, displayed information after receiving the instructions from the first node.

16. A method comprising:
creating, by a display module, a first list of signal strengths, wherein the first list of signal strengths is created by:
(i) searching for a beacon on a wireless channel in a network;
(ii) when the beacon is present on the wireless channel, receiving the beacon and storing a signal strength of the beacon in the first list of signal strengths;
repeating, by the display module, the steps of (i) and (ii) until all wireless channels in the network have been searched, wherein the repetition populates the first list of signal strengths with:
a first signal strength of a first beacon transmitted by a first node on a first wireless channel, and
a second signal strength of a second beacon transmitted by a second node on a second wireless channel;
sorting, by the display module, the first list of signal strengths, wherein the first list of signal strengths is sorted in an order of decreasing signal strengths such that a first identifier of the first node precedes a second identifier of the second node in the sorted list; and
transmitting, by the display module, a request for association using the sorted list, wherein transmission of the request commences with the request being transmitted to the first node as a result of the display module identifying that the first identifier precedes the second identifier in the sorted list.

17. The method of claim 17, wherein the first beacon and the second beacon are respectively transmitted by the first node and the second node autonomously and continually without receiving any beacon requests from the display module.

18. The method of claim 17, wherein the steps of (i) and (ii) are repeated by the display module regardless of whether or not beacons have been received by the display module on their respective wireless channels.

19. A method comprising:
broadcasting, by a first node, a first beacon via a first wireless channel, wherein the first beacon is broadcasted autonomously and continually;
receiving, by the first node, via the first wireless channel, a request from an electronic shelf label (ESL) and a unique identifier of the ESL, wherein the request is firstly transmitted to the first node by the ESL;
transmitting, by the first node, an affirmative response to the ESL as a result of determining that the unique identifier matches one of a plurality of identifiers in a predefined list, wherein the response enables the ESL to associate with the first node;
receiving, by the first node, a list of signal strengths from the ESL after association;
transmitting, by the first node, the list to a server;
receiving, by the first node, a command from the server to remove the unique identifier of the ESL from the predefined list when a signal strength associated with the first node in the list of signal strength is not the strongest signal strength in the list;
removing, by the first node, the unique identifier from the predefined list in response to receiving the command, thereby causing the first node and the ESL to disassociate from one another.
